(19) United States
(12) Patent Application Publication
(10) Pub. No.: US 2005/0183065 A1
(43) Pub. Date: Aug. 18, 2005

(54) Performance counters in a multi-threaded processor

(76) Inventors: Mario I. Wolczko, San Carlos, CA (US); Adam R. Talcott, San Jose, CA (US)

Correspondence Address: HAMILTON & TERRILE, LLP, P.O. BOX 203518, AUSTIN, TX, 78720, US

(21) Appl. No.: 10/779,216

(22) Filed: Feb. 13, 2004

(51) Int. Cl. G06F 9/44

(52) U.S. Cl. 717/124

(57) ABSTRACT

A method of performance counting within a multi-threaded processor. The method includes counting events within the processor to provide an event count, and attributing the event count to events occurring within a thread of the processor or to events occurring globally within the processor.

### BACKGROUND OF THE INVENTION

1. Field of the Invention

The present invention relates to microprocessor design and more particularly performance counters.

2. Description of the Related Art

Microprocessor designers, system designers and system software designers often count the number of times a particular event occurs in a microprocessor to gage the performance of the system being designed. Performance counters are typically used for this purpose. Each time a particular event occurs, the associated performance counter is incremented. The performance counters are typically located within the same integrated circuit as the circuits being monitored by the performance counters.

The performance counters may be read at any time to determine the number of times a particular event occurred. For example, if the average number of instructions issued per clock cycle is of interest, a performance counter that counts the number of clock cycles and another performance counter that counts the number of instructions issued could be used. By reading the values in the performance counters, a performance analyst can gain a better understanding of how efficiently microprocessor resources are used.

One challenge associated with performance counters is that, at any given time in a multithreaded processor, instructions from different threads may be executing simultaneously. Thus, unless the thread execution is taken into account, the performance counter may record events from more than one thread, and the associated information may not be an accurate reflection of the activity within a particular thread.

### SUMMARY OF THE INVENTION

In accordance with the present invention, a performance counter mechanism is provided which counts events attributable to one thread or events which are global; partitions physical counters among multiple threads; allows a thread to start and stop all of the counters assigned to it; allows one thread's counters to be protected from another thread or to allow the threads to share one or more counters; and, determines which thread receives an overflow interrupt when a performance counter overflows.

In one embodiment, the invention relates to a method of performance counting within a multi-threaded processor. The method includes counting events within the processor to provide an event count, and attributing the event count to events occurring within a thread of the processor or to events occurring globally within the processor.

In another embodiment, the invention relates to a method of performance counting within a multi-threaded processor. The method includes counting a plurality of events within the processor via a plurality of counters to provide a respective plurality of event counts, assigning at least one counter to a thread, and enabling the thread to start and stop all counters assigned to the thread.

In another embodiment, the invention relates to a method of performance counting within a multi-threaded processor. The method includes counting a plurality of events within the processor to provide respective plurality of event counts via a respective plurality of counters, and partitioning the plurality of counters among multiple threads of the processor.

In another embodiment, the invention relates to a method of performance counting within a multi-threaded processor. The method includes counting a plurality of events within the processor to provide respective plurality of event counts via a respective plurality of counters, assigning a first counter to a thread, assigning a second counter to another thread, and determining which thread receives an overflow interrupt based upon when one of the first and second counters overflows.

In another embodiment, the invention relates to an apparatus for performance counting within a multi-threaded processor. The apparatus includes means for counting events within the processor to provide an event count, and means for attributing the event count to events occurring within a thread of the processor or to events occurring globally within the processor.

In another embodiment, the invention relates to a performance counter for counting events within a multi-threaded processor which includes a counter module and an attribution module. The counter module counts events within the processor to provide an event count. The attribution module attributes the event count to events occurring within a thread of the processor or to events occurring globally within the processor.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic block diagram of a processor which includes a performance counter module.

FIG. 2 shows a schematic block diagram of a performance counter module.

FIG. 3 shows a diagrammatic representation of an entry in a status register.

FIG. 4 shows a diagrammatic representation of an entry in a performance instrumentation counter.

FIG. 5 shows a diagrammatic representation of an entry in a Performance Control Register.

### DETAILED DESCRIPTION

A performance counter architecture for use in a multithreaded processor is described. In the following description, numerous details are set forth, such as particular bit patterns, functional units, number of counters, etc. It will be apparent, however, to one skilled in the art, that the present invention may be practiced without these specific details. In other instances, well-known structures and devices are shown in block diagram form, rather than in detail, in order to avoid obscuring the present invention.

In one embodiment, multiple performance counters are fabricated on the same integrated circuit (IC) die as the circuits to be monitored. The performance counters may be incrementers or full adders. Each performance counter may be coupled to individual performance monitoring portions (i.e., sources of performance events) dynamically, via one or more performance buses. As described herein, a performance monitoring portion is a portion of an integrated circuit (IC) which has a designated function. One example of a performance monitoring portion is a functional unit. Control and filter logic implement a bus protocol on the performance buses to control when a performance counter monitors a particular event of interest at a given time.

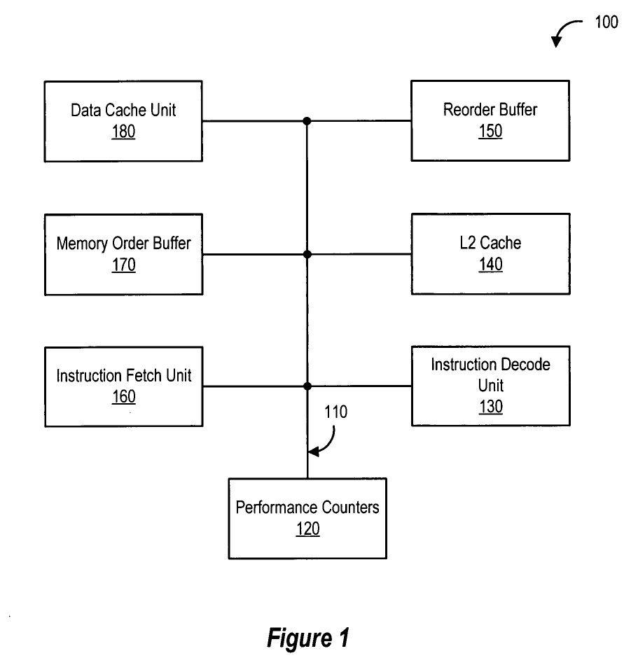

FIG. 1 is a block diagram of a performance counter architecture in a microprocessor according to the present invention. Referring to FIG. 1, a performance counter module 120 is coupled to various performance monitoring portions by performance buses 110. The performance monitoring portions coupled to performance buses 110 may be any functional unit in a microprocessor 100 such as instruction decode unit 130, second level (L2) cache memory 140 (which may or may not be located on a different integrated circuit die), reorder buffer 150, instruction fetch unit 160, memory order buffer 170, data cache unit 180, or a clock generation unit (not shown). Other performance monitoring portions in addition to those listed may also be coupled to performance buses 110, such as execution units. According to one embodiment, the performance counter module 120 includes sixteen performance counters; however, any number of performance counters may be used (e.g., 2, 3, 4, etc.).

Each performance counter may be configured to be selectively coupled to each functional unit by a dedicated bus; however, alternative architectures may also be used. For example, one performance counter may be coupled to the processor clock while one or more performance counters are selectively coupled to the functional units. Alternatively, one performance counter may be selectively coupled to one of a first set of functional units while another performance counter is selectively coupled to one of a second set of functional units. Also, one performance counter may be coupled to one functional unit, while another is selectively coupled to one of a plurality of functional units.

The performance counter module 120 includes a plurality of aspects. More specifically, in the performance counter module 120, performance events are characterized as to whether they are attributable to a specific thread or not. For example, the count of instructions retired is associated with a thread; the count of cycles is not. Additionally, in the performance counter module 120, the counters may be selectively partitioned into banks. The number of counters attributed to a particular thread may be programmably controlled.

Providing the performance counter module 120 with the performance counters partitioned as two banks allows a software policy to choose whether in a single-thread mode the executing thread has control over 0, 8 or 16 counters and in multi-thread mode whether the division of counters between the two threads is 0:16, 8:8 or 16:0. Thus, the operating system may allocate counters asymmetrically to threads.

Each bank can be bound to a thread by setting a configuration register. The binding of a bank to a thread determines which thread can access the counters in that bank in user mode, which thread receives a trap when the counter overflows, which thread-specific events are counted (e.g., if a counter is bound to thread 0 and configured to count retired instructions, the counter counts the retired instructions for thread 0 and does not count retired instructions for thread 1); and, which thread can start and stop the counters in that bank (e.g., this function may be manifested as privileged control, so that any thread is allowed to start or stop counters of the thread or this function may be controlled in a user mode).

The performance counters bound to a thread are started and stopped using a per-thread control bit. This feature allows a thread to start and stop only the counters that are bound to the thread. Additionally, notification of a pending overflow interrupt is provided via a per-thread status notification.

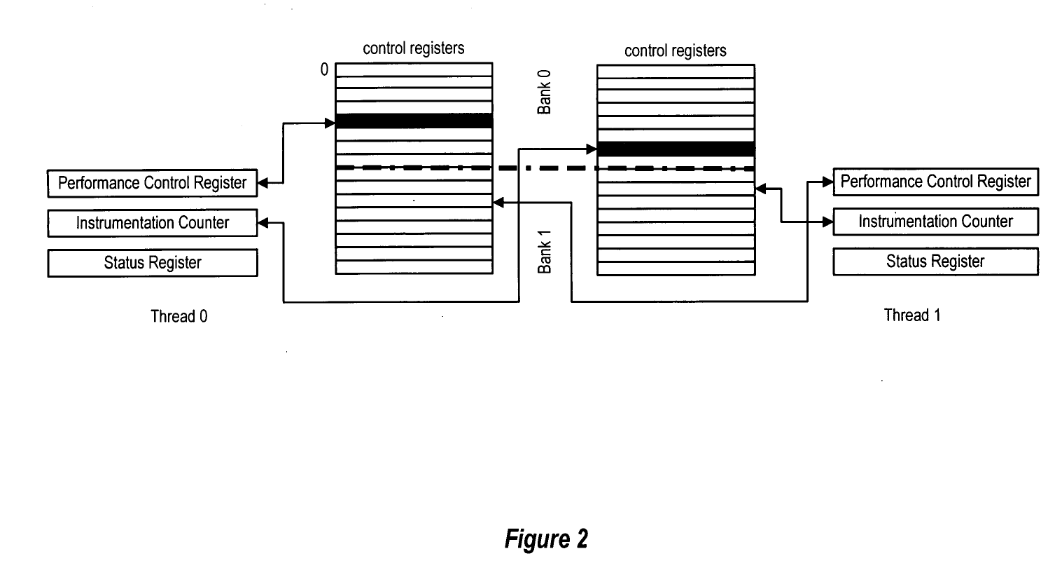

Referring to FIG. 2, in one embodiment, the performance instrumentation hardware in the processor 100 and specifically, the performance counter module 120 includes performance instrumentation counters (PICs). The processor 100 may include, e.g., 16 64-bit counter registers. Each 64-bit counter register contains a single 32-bit counter and an overflow bit. Only one counter register is accessed at a time by a thread, through the PIC state register (SR), using read and write instructions.

In one embodiment, the processor 100 includes a separate Performance Control Register (PCR) associated with each counter register. The instrumentation counters are individually controlled through a corresponding performance control register. The notation for the performance instrumentation counter and performance control register may be generalized as PIC[i] and PCR[i] to refer to the ith counter and control register, respectively. A status register provides additional information about the counters, and allows a software thread to start and stop all counters that are bound to the thread.

Each counter in a counter register can count one kind of event from a selection of a plurality of event types. For each counter register, the corresponding control register selects the event type being counted. A counter may be incremented whenever an event of the matching type occurs. A counter may be incremented by an event caused by an instruction which is subsequently flushed (e.g., due to mis-speculation).

In multi-thread mode, each thread has its own copy of the status register, but there is a single, global file of counters and their controls. This file is split into banks (e.g., two banks). Each bank is bound to a specific thread. A thread running in non-privileged mode may not access a counter in a bank bound to another thread. This allows the operating system to assign all counters to one thread, or to split the counters between threads.

Software manages the binding of threads to banks. In particular, if it is possible for a thread to be rebound to a different bank, software manages this reassignment. For example, process A is bound to bank 0, process B is bound to bank 1; later, process A is de-scheduled, and process C is scheduled and bound to bank 0; later still, thread B is de-scheduled, and subsequently process A is rescheduled and bound to bank 1. In this example, thread A is first bound to bank 0, and then to bank 1. In this example, user-level code cannot rely on the bank assignments being maintained from one instruction to the next; it is recommended that the counters be made privileged by the operating system and that system software maintain the mapping from threads to banks (and provide an interface for user code to read its counters, regardless of in which bank they reside).

Overflow of a counter can cause a trap to be raised. Overflow traps can be enabled on a per-counter basis. Overflow of a counter is recorded in the corresponding PIC state register, in the OVF field. The traps are imprecise because the trap program counter does not indicate the instruction that caused the overflow.

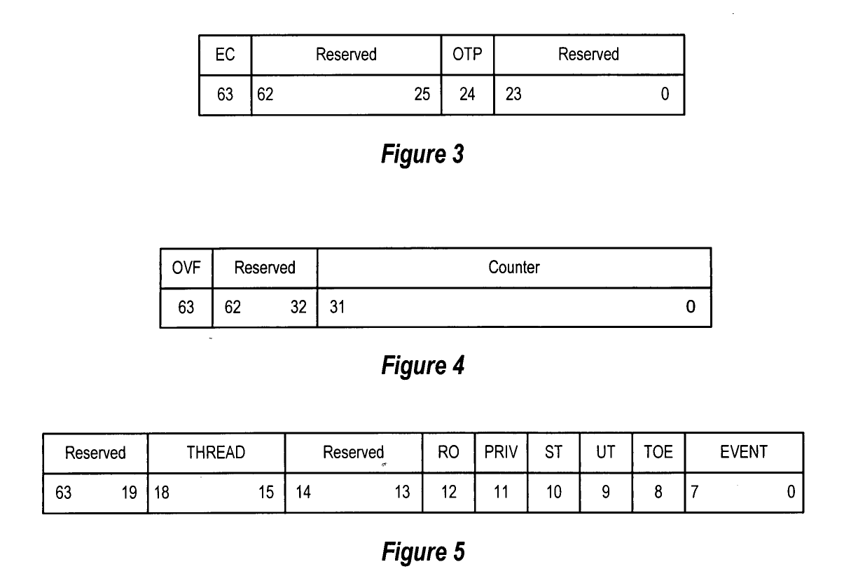

Referring to FIG. 3, the performance counter module 120 includes a status register. The status register controls and accesses global information related to all counters bound to a thread. Each thread has its own status register. The status register is only accessed in privileged mode. The status register includes an enable counter (EC) field and an overflow trap pending field (OTP).

The enable counter field is set to 1 to enable counting across all counters in banks bound to the current thread and set to 0 to disable counting across all counters in banks bound to the current thread.

The overflow trap pending field indicates that an overflow trap is pending. The overflow trap pending field is computed by hardware from the overflow and trap on enable fields of counters and their control registers bound to the thread.

Referring to FIG. 4, all counter registers are accessed using read and write state register instructions. The read and write instructions specify which particular counter is accessed. The performance instrumentation counter includes a counter field and an overflow bit (OVF).

The overflow bit is set when the counter overflows (i.e., when the counter wraps around to 0). The overflow field is cleared by software. An overflow trap may be caused when the overflow bit is set to 1 (either by an overflow, or software writing a 1 into the field). Additional status and control information relating to the performance instrumentation counter can be accessed via the performance control register.

Referring to FIG. 5, the control register associated with each performance counter register is accessible through the performance control register. The specific control register being accessed is selected by a read/write instruction. The performance control register includes a thread field (THREAD), a read only field (RO), a privilege field (PRIV), a system/user trace field (ST), a user trace field (UT), a trap overflow enable field (TOE), and an event field (EVENT).

The thread field is wide enough to identify all threads executing on the processor. The thread field indicates the thread owning a bank of counters. For each bank, the thread field in each performance control register within the bank indicates the ownership of that bank (e.g., PCR[0-7] for bank 0, PCR [8-15] for bank 1). However, writes to this field are ignored except for the first PCR in the bank (PCR[0] and PCR[8]). The owner of a counter determines: which thread can access that counter in user mode (assuming this is allowed by the PRIV field of the corresponding PCR); which thread will receive a trap when the counter overflows (assuming PCR.TOE (trap on enable) for that counter is 1); and, which thread starts or stops the counter via the enable counter field in the status register.

The read only field indicates that the counter is read only. When the value stored in the read only field is set, any non-privileged write to the associated counter register raises a privilege violation trap. The privileged field indicates that the counter is privileged. When the value stored in the privileged field is set, any non-privileged access (read or write) to the associated counter register raises a privilege violation trap. The system and user trace fields enable counting of events from instructions executing in system and user modes, respectively. The trap overflow enable bit controls whether or not the thread to which this counter is bound will receive overflow traps from this counter. When the trap overflow enable field is enabled, a trap is raised whenever the counter overflows. This trap is imprecise. Simultaneous or near-simultaneous overflows of multiple counters may be mapped into a single trap. The trap handler inspects the overflow field in each counter register to determine which counter or counters overflowed. The event field selects the type of event being counted.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while a particular processor architecture is set forth, it will be appreciated that variations within the processor architecture are within the scope of the present invention. Also, while various functional aspects of how the performance counter module interacts with and monitors the performance of certain aspects of processor performance, it will be appreciated that variations of the interaction with and monitoring of aspects of processor performance are within the scope of the present invention.

Also for example, the size of the banks and how finely the set of counters can be partitioned among the threads may be adjusted based upon the performance counter mechanism design. At one extreme, the performance counter mechanism can provide counters in which each counter can be bound to a thread independently of all the other counters within the performance counter mechanism. At the other extreme all counters are bound to the same thread. In one embodiment, the number of banks equals the number of threads, thus allowing for a fair partition but not costing as much as a finer grained partition.

Also for example, whether the counters are virtualized with respect to user level code may be varied. Virtualizing the counters would enable a user level thread to access a counter by using a name unaffected by the mapping of threads to hardware threads. In one embodiment, the counters are not virtualized, instead, the operating system is responsible for managing the mapping from user level logical counters to hardware level physical counters.

Also for example, variations on the register configurations of the performance counter circuit are within the scope of the present invention. For example, control information may be integrated into a specific counter register as compared to using a separate performance control register associated with each counter register. Also for example, each counter register may include an individual enable bit as compared to using a corresponding performance system status register.

Also for example, the above-discussed embodiments include modules that perform certain tasks. The modules discussed herein may include hardware modules or software modules. The hardware modules may be implemented within custom circuitry or via some form of programmable logic device. The software modules may include script, batch, or other executable files. The modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method of performance counting within a multi-threaded processor comprising:
counting events within the processor to provide an event count; and
attributing the event count to events occurring within a thread of the processor or to events occurring globally within the processor.

2. The method of claim 1 further comprising:
binding counters to a thread.

3. The method of claim 2 further comprising:
starting and stopping the counters bound to the thread independently of any other counters.

4. The method of claim 1 further comprising:
globally starting and stopping the counters for all events being counted.

5. The method of claim 1 further comprising:
partitioning the counters among a plurality of threads of the processor.

6. The method of claim 1 further comprising:
determining whether a particular thread receives an overflow interrupt.

7. A method of performance counting within a multi-threaded processor comprising:
counting a plurality of events within the processor via a plurality of counters to provide a respective plurality of event counts;
assigning at least one counter to a thread; and
enabling the thread to start and stop all counters assigned to the thread.

8. The method of claim 7 further comprising:
enabling the thread to globally start and stop all of the plurality of counters.

9. A method of performance counting within a multi-threaded processor comprising:
counting a plurality of events within the processor to provide respective plurality of event counts via a respective plurality of counters; and,
partitioning the plurality of counters among multiple threads of the processor.

10. A method of performance counting within a multi-threaded processor comprising:
counting a plurality of events within the processor to provide respective plurality of event counts via a respective plurality of counters;
assigning a first counter to a thread;
assigning a second counter to another thread; and
determining which thread receives an overflow interrupt based upon when one of the first and second counters overflows.

11. An apparatus for performance counting within a multi-threaded processor comprising:
means for counting events within the processor to provide an event count; and
means for attributing the event count to events occurring within a thread of the processor or to events occurring globally within the processor.

12. The apparatus of claim 11 further comprising:
means for binding counters to a thread.

13. The apparatus of claim 11 further comprising:
means for starting and stopping the counters bound to the thread independently of any other counters.

14. The apparatus of claim 11 further comprising:
means to globally starting and stopping the counters for all events being counted.

15. The apparatus of claim 11 further comprising:
means for partitioning the counters among a plurality of threads of the processor.

16. The apparatus of claim 11 further comprising:
means for determining whether a particular thread receives an overflow interrupt.

17. A performance counter for counting events within a multi-threaded processor comprising:
a counter module, the counter module counting events within the processor to provide an event count; and
an attribution module, the attribution module attributing the event count to events occurring within a thread of the processor or to events occurring globally within the processor.

18. The performance counter of claim 17 further comprising:
a counter control module, the counter control module enabling the thread to start and stop the counting for events attributed to the thread.

19. The performance counter of claim 17 wherein:
the counter control module enables the thread to globally start and stop the counting of all events.

20. The performance counter of claim 17 wherein:
the counter module includes a plurality of counters; and,
the counters may be partitioned among a plurality of threads of the processor.

21. The performance counter of claim 11 wherein:
the counter module indicates whether a particular thread receives an overflow interrupt.
